(19) United States
(12) Patent Application Publication
(10) Pub. No.: US 2017/0086636 A1
(43) Pub. Date: Mar. 30, 2017

(54) Cleaning and Drying Device Utilizing Removably-Attached Material

(71) Applicant: Michael G. Apcar, Los Angeles, CA (US)

(72) Inventor: Michael G. Apcar, Los Angeles, CA (US)

(21) Appl. No.: 14/867,787

(22) Filed: Sep. 28, 2015

(51) Int. Cl. A47L 13/256; B24D 15/02; B25G 3/38; B25G 1/10; A47L 13/16

(52) U.S. Cl. CPC A47L 13/256; B25G 1/102; A47L 13/16; B25G 3/38; B24D 15/023

(57) ABSTRACT

A cleaning and drying device utilizing removably attached material that includes a material plate, two material retaining clips, and a handle or hand grip. The two clips are hingedly attached to the plate. When upward pressure is applied, the clips pivot upward from a center point, thereby upwardly-extending an outer edge of each clip. An edge of a material is then inserted between each clip's outer edge and the material plate. When pressure is removed, the two clips are forced downward, thereby trapping the material between the clips and the plate. Once the material is secured, the device can be used to clean or dry a surface. After cleaning or drying, the material is removed and a new material is attached. The material can be any fabric/cloth including rags, old clothing, towels or any other material, thereby precluding the requirement to use special pads or other proprietary materials.

### TECHNICAL FIELD

The invention generally pertains to cleaning devices such as a mop, and more particularly to a cleaning device utilizing a removably-attached, clip-on material, which can consist of any fabric or cloth.

### BACKGROUND ART

Throughout the world, especially in developed nations, there is a high priority in maintaining cleanliness. This is applied to both personal hygiene as well as living and working in a clean environment. To achieve and maintain cleanliness a large number of products have been developed. Personal hygiene products include soap, body wash, and hair shampoo, while environmental products include liquid and solid chemical products or solutions, and devices that facilitate the use of or application of cleaning products.

One of the most ubiquitous and long-term devices is a mop. For cleaning all types of floors, a mop has long been the preferred device. For much of its life, the design of a mop has remained the same. A handle to which is attached a cleaning head that typically consists of a multiplicity of fabric strips. The head/strips were inserted into a bucket or container having water or a mixture of water and cleaning solution. The head/strips was then placed on a floor and manually moved back and forth to clean the floor. After a while the head/strips were wringed out by applying pressure that would force the dirty water out/off the strips. This process was repeated numerous times, depending on the size of the floor being cleaned.

In recent years mop design has improved and, while the traditional mop design is still utilized, there are now mops that are easier to use and provide a more hygienic cleaning experience. The most common new mop design includes a handle to which is attached a head with a permanently attached or removable material, which is typically in the form of a pad. When a person wishes to use the mop with the removable material he/she will attach a material to the head and use the mop as is commonly preferred. Once finished, the material is removed and discarded. Some modern mop designs even include a built-in reservoir of cleaning fluid which can be dispensed onto the material.

Although these modern designs are an improvement over the original designs, and provide a quick and easy method of mopping, there are problems. For the mops with the permanently attached material, over time the material, which is typically cloth, becomes soiled and/or deteriorates. When this occurs the entire mop must be discarded. For the mops that use a removable material, which is typically a disposable pad or a cloth/fabric that cleans and attracts dust, each time the mop is used many people will attach a new material. This essentially creates a mop with a single-use material. The use of a new material each time the mop is utilized imposes a significant cost to the use of the mop, and creates more waste as each material is discarded. This is important in today's world of environmental consciousness and “green” living.

What is needed is a mop that can provide all of the benefits of a modern hygienic mop with removable material, without the negative aspects. Preferably, the mop would be able to use any fabric as a material, thereby allowing a fabric such as a rag or an old/worn article of clothing to be utilized as a material. A mop with this capability would save a considerable amount of money by not requiring the purchase/use of dedicated materials, and would create a more environmentally friendly cleaning device.

A search of the prior art did not disclose any literature or patents that read directly on the claims of the instant invention. However, the following U.S. patents are considered related:

| PATENT NO. | INVENTOR | ISSUED |
|---|---|---|
| 3,760,450 | Griffin et al | 25 Sep. 1973 |
| 4,962,563 | Bachar | 16 Oct. 1990 |
| 5,915,437 | Petner | 29 Jun. 1999 |
| 2004/0244133 | Li | 9 Dec. 2004 |

The U.S. Pat. No. 3,760,450 patent discloses a dust mop with a throwaway mop head. The dust mop includes an elongated carrier member to which is swivelly mounted a mop handle. The carrier member includes an upper rigid portion and a lower cushion portion. A disposable mop head is mounted against the lower cushion portion and includes a mop element made from an absorbent material. The mop element is attached to a non-woven fiber cloth backing material that is folded upward and secured by releasable retainer means.

The U.S. Pat. No. 4,962,563 patent discloses a clamp for long-handle floor-washing wipers or scrub-brushes. The clamp comprises an elongated head for a wiper blade or brush carried at the end of a broomstick, and is adapted to releasably hold a rag and prevent its slipping-off the head during use. The clamp is comprised of two springy arms extending in alignment in a common plane, and a frame holding the arms by the respective outer ends thereof. When the clamp is mounted, the arms become flexed, thereby displacing the frame into either an engaging or a disengaging position with respect to the wiper head.

The U.S. Pat. No. 5,915,437 patent discloses a dual bonnet clips that are secured to the top surface of the head of dust type mop. Each clip has two arms which, when pushed down at their e4sepctive ends, causes the side sections of the clip to pivot up from the top surface of the mop. In this raised position, the side surfaces of the mop's bonnet can be placed under the side sections. When the downward pressure on the ends of the arm is released, the side sections of the clips pivot down and lower onto the bonnet, securing the bonnet to the mop head.

The 2004/0244133 publication discloses a floor mop for use with any washable fabric sheet or cloth. The mop comprises a flat rectangular plate as mop head with a top surface and a bottom surface. The top surface is attached to an elongated handle and the bottom surface being planar and covered with a layer of elastic plate with a rough surface. On the top surface of the plate are at least two spring operated clips. Any fabric sheet suitable for floor washing can be secured in place to the mop head to cover the bottom surface. A user can replace a worn mop sheet with any fabric sheet or a cloth.

For background purposes and indicative of the art to which the invention relates, reference may be made to the following remaining patents found in the patent search.

| PATENT NO. | INVENTOR | ISSUED |
|---|---|---|
| 2,018,498 | Leonard | 22 Oct. 1935 |
| 2,108,727 | Rogers | 15 Feb. 1938 |
| 2,254,648 | Gilsdorf | 2 Sep. 1941 |
| 2,318,094 | Petzold, Jr. et al | 4 May 1943 |
| 3,656,207 | Short | 18 Apr. 1972 |
| 3,711,886 | Strauss | 23 Jan. 1973 |
| 3,728,756 | Argeris et al | 24 Apr. 1973 |
| 3,735,441 | Shortte, Jr. | 29 May 1973 |
| 3,798,700 | Popeil | 26 Mar. 1974 |
| 4,553,282 | Batchelor | 19 Nov. 1985 |
| 4,850,072 | Smith | 25 Jul. 1989 |
| 5,461,749 | Ahlberg et al | 31 Oct. 1995 |
| 5,481,777 | Nenninger | 9 Jan. 1996 |
| 5,615,442 | Schroeck et al | 1 Apr. 1997 |
| 5,768,736 | Preston | 23 Jun. 1998 |
| 6,986,618 | Hall et al | 17 Jan. 2006 |
| 7,774,889 | Weaver | 17 Aug. 2010 |
| 7,926,142 | Bizzotto | 19 Apr. 2011 |
| 8,087,121 | Michelson et al | 3 Jan. 2012 |
| 8,341,795 | Michelson et al | 1 Jan. 2013 |
| 2004/0265037 | Vosbikian et al | 30 Dec. 2004 |
| 2005/0011536 | Hofte et al | 20 Jun. 2006 |
| 2006/0137123 | Sampaio | 29 Jun. 2006 |
| 2006/0195996 | Petner | 7 Sep. 2006 |
| 2007/0151059 | Petner et al | 5 Jul. 2007 |
| 2010/0132147 | Young | 3 Jun. 2010 |
| 2011/0101249 | Besnard | 5 May 2011 |
| 2011/0289714 | Scott et al | 1 Dec. 2011 |
| 2012/0195674 | Mandle et al | 2 Aug. 2012 |
| 2013/0283558 | Gibis et al | 31 Oct. 2013 |
| 2013/0340187 | Bober et al | 26 Dec. 2013 |

### DISCLOSURE OF THE INVENTION

In its basic design, the cleaning and drying device having removably attached material is comprised of a material plate, a first material retaining clip, a second material retaining clip and a handle. The first and second material clips are hingedly attached to an upper surface of the material plate. When each of the material clips is grasped and pulled upward from an outer edge, each clip pivots upward under pressure from a center point, thereby upwardly extending the respective outer edge of each clip. When the clips are each maintained in the upward position, an edge of a material can be inserted into a space between the material plate and each clip.

When each clip is released and pressure removed, each clip is forced downward, trapping the edges of the material between the outer edge of each clip and the upper surface of the material plate.

Once in place, the material is secured at the edges and around a lower surface of the material plate, and can be used to clean a surface such as a floor, a wall or a tabletop. After cleaning, the material can be removed and a new material can be attached for subsequent use.

One of the major benefits to using the device is that a person is not limited to using specially-designed cleaning pads on the device. By use of the clips, any material such as rags or old clothing can be effectively utilized as a cleaning and/or drying material. This ability significantly reduces the cost of using the device. Conventional mops that use the specialty designed pads require a person to purchase only the pads that will work with a particular mop, and the pads must typically be purchased in bulk, even if a person only requires one or two. The instant device allows a person to simply use any material that is commonly found in most households.

In view of the above disclosure, the primary object of the invention is to provide a cleaning and drying device having removably attached material that can utilize any piece of fabric as a material which is easily attached and removed from the device.

In addition to the primary object, it is also an object of the invention to provide a cleaning and drying device having removably attached material that:
is easy to use,
can use other types of material such as an abrasive cleaning pad,
can use non-materials such as sand paper,
can be used to clean various surfaces,
can be used on wet or dry surfaces,
can use an elongated rod handle or a short hand grip,
can be made in various sizes,
can include a material plate that is expandable to increase surface area,
is a green product that is good for the environment, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPION OF THE DRAWINGS

FIG. 1 is an orthographic front view of a cleaning and drying device utilizing removably attached material.

FIG. 2 is an exploded view showing the elements that comprise the preferred embodiment of the device.

FIG. 3 is a top view of the device.

FIG. 4 is a side elevational view of the device showing two material retaining clips in an upward, open position and a piece of material around a material plate.

FIG. 5 is a side elevational view of the device showing the two clips in a downward closed position.

FIG. 6 is a side elevational view of the device showing the two clips having serrated edges.

FIG. 7 is an orthographic front view of the device with an ergonomic hand grip.

### BEST MODE FOR CARRYING OUT THE INVENTION

The best mode for carrying out the invention is presented in terms that disclose a preferred embodiment for a cleaning and drying device having removably attached material, hereafter “device 10”. Many conventional cleaning devices, such as a mop, require the attachment and use of special cleaning pads. Attachment members are utilized to maintain the pads on the mop/s head. The attachment members can often be complicated which can be costly and prone to damage or breakage. The special pads typically only work with a particular brand or a model of mop. So, basically once a person purchases a mop, they must continually purchase/replace the pads for the duration of the life of the mop. The pads usually function adequately well, but the cost of continually purchasing new pads can require a significant amount of money, especially over years of use.

The instant device 10 offers a solution to this problem by providing a cleaning and drying device 10, which can be in the form of mop with an elongated handle or a hand-held device, and that can use any fabric as a cleaning or drying material in place of conventional pads. For example, the cleaning or drying material fabric can consist of used/old clothing, towels, cloth or in fact any fabric. This functional capability significantly reduces the cost and increases the ease of using the device 10.

Additionally, conventional tools or devices are typically micro-fiber based, which does not provide much friction during use. The instant device 10 utilizes any fabric or cloth which has much greater friction capabilities, thereby providing significantly better cleaning and/or drying functionality over micro-fiber based tools or devices.

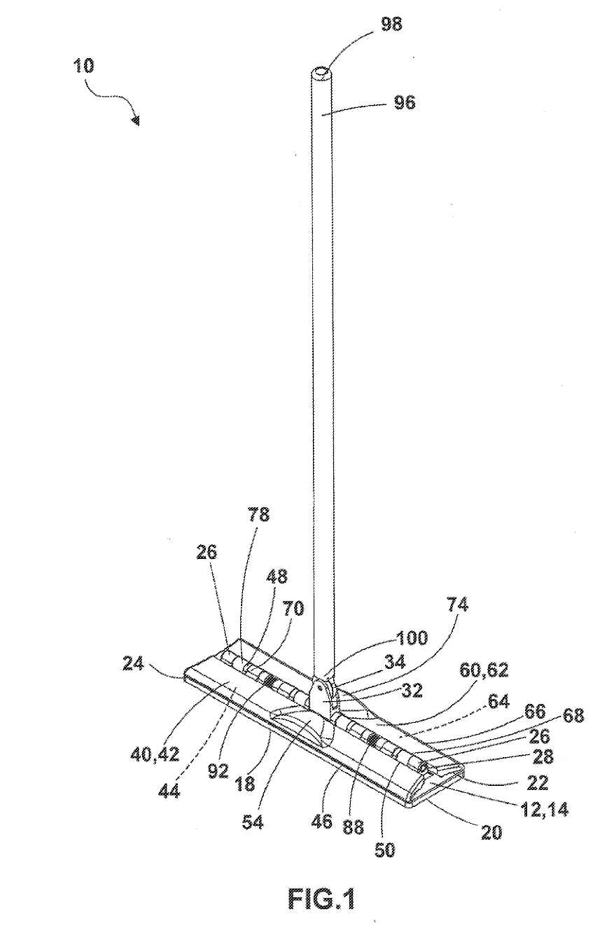

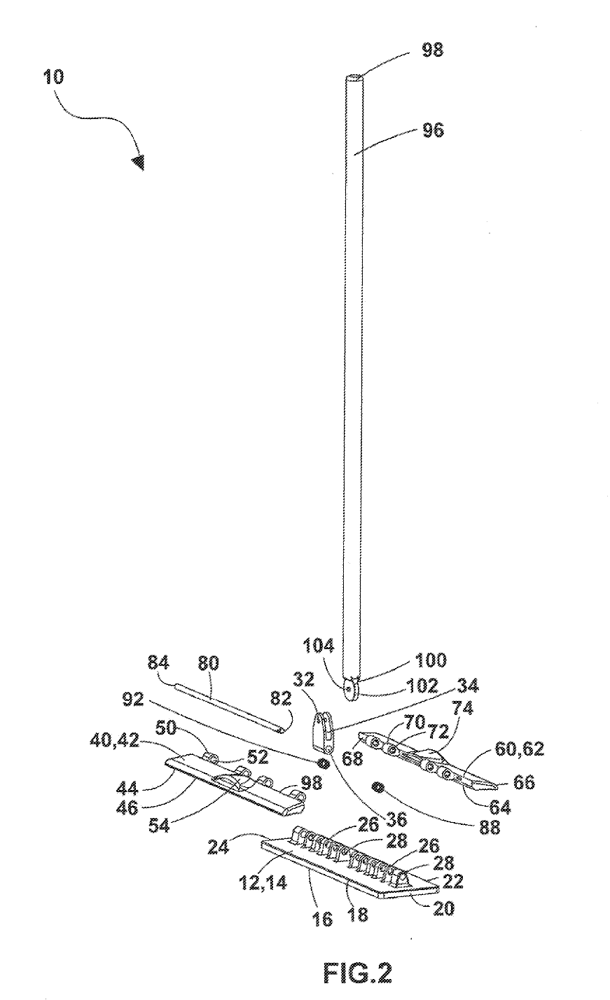

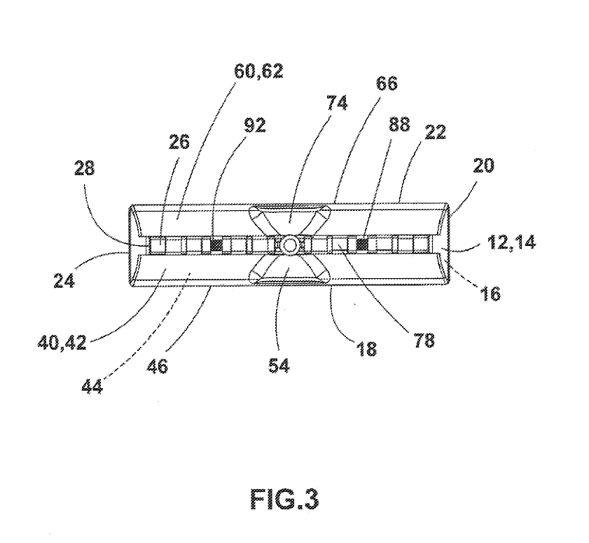

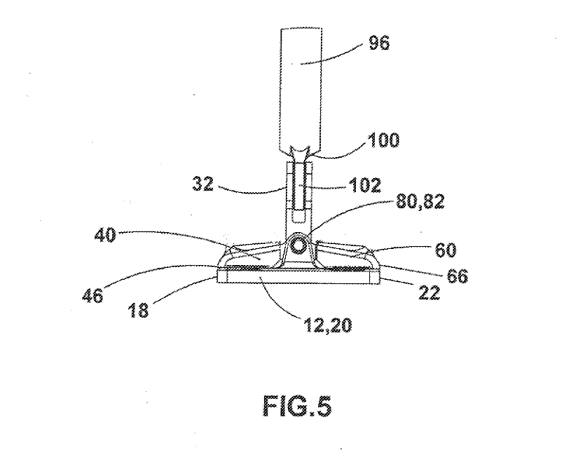

The device 10, as shown in FIGS. 1-7, is comprised of the following major elements: a material plate 12, a first material retaining clip 40, a second material retaining clip 60 and a pressure assembly 78.

The material plate 12, which is often referred to as a “mop head”, is shown in FIGS. 1-7 and is comprised of an upper surface 14, a lower surface 16, a first edge 18, a second edge 20, a third edge 22, a fourth edge 24, a plurality of upward-extending tabs 26 each having an opening 28 therethrough, and an upward-extending hinge 32 with a slot 34 having a lower opening 36.

The first material retaining clip 40, as shown in FIGS. 1-7, extends the longitudinal length of the material plate 12. The clip 40 comprises an upper surface 42; a lower surface 44; a front edge 46; a rear edge 48; at least two, and preferably three tab interfaces 50 each having an opening 52 and that extend from the rear edge; and a finger grip 54 that extends upward from the upper surface 42.

The second material retaining clip 60, as shown in FIGS. 1-7, is a mirror image of the first clip and also extends the longitudinal length of the material plate 12, facing the opposite direction, on the opposite side, from the first clip 40. The second clip 60 is comprised of an upper surface 62; a lower surface 64; a front edge 66; a rear edge 68; at least two, and preferably three tab interfaces 70 each having an opening 72 and that extend from the rear edge; and a finger grip 74 that extends upward from the upper surface 62.

The pressure assembly 78, as shown in FIGS. 1, 3 and 7, is comprised of a pivot rod 80 with a first end 82 and a second end 84, a first spring 88, and a second spring 92.

The two material retaining clips 40,60 are positioned on the upper surface 14 of the material plate 12. One the tab interfaces is inserted downward between a pair of the upward-extending tabs 26 such that the respective opening 52,72 on the tab interfaces 50,70 and the upward-extending tabs 26 are aligned. The upward-extending hinge 32 is located at the substantial center between two groups of tab interfaces 50,70 and upward-extending tabs 26, and the lower opening 36 on the hinge is also aligned with the openings 52,72 on the tab interfaces and the upward-extending tabs. The first end 82 of the rod 80 is inserted into and sequentially passes through the openings on the two groups of tab interfaces 50,70 and upward-extending tabs 26 and the hinge 32. As the pivot rod 80 is inserted, the first spring 88 is placed in alignment within the first group such that the pivot rod 80 passes through and maintains the spring 88 in position, and the second spring 92 is placed in alignment within the second group such that the pivot rod 80 passes through and maintains the second spring 92 in position. Once the pivot rod 80 is completely inserted, the pressure assembly is functional, facilitating the manual upward-extending, by use of the finger grip 54, of the first material retaining clip 40 under pressure. With the first retaining clip 40 in the upward position, an edge of a material 110 can be inserted between the front edge 46 of the first retaining clip 40 and the upper surface 14 of the material plate 12. When pressure is removed, the clip 40 is forced downward, trapping the Material 110 between the clip 40 and the plate 12. The same operation is performed with the second material retaining clip 60 on the opposite end of the material 110. When both ends of the material 110 are secured, the device 10 can be utilized to clean a surface, such as a floor, wall or tabletop.

As shown in FIGS. 1-6, a handle 96 extends upward from the material plate 12. The handle 96 has an upper end 98 and a lower end 100, and is preferably an elongated rod that facilitates the use of the device 10 by a person standing and holding the handle 96. Located at the handle's lower end 100 is an attachment tab 102 having an opening 104. The attachment tab 102 is inserted into the slot 34 on the hinge 32. A pin is inserted through the slot 34 and the opening 104, thereby hingedly securing the handle 96 to the material plate 12.

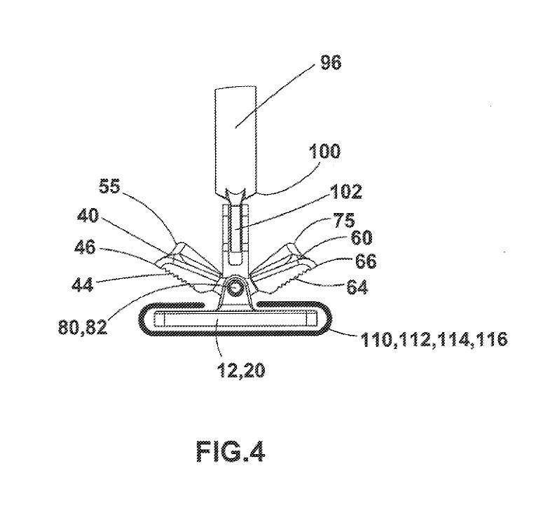

As previously disclosed, the device 10 can use different types of material 110, such as a cloth 112 or a pad 114. As shown in FIG. 4, a material made of fabric such as the cloth 112 is most commonly envisioned. The cloth 112 can he a rag, old clothing such as a T-shirt, a towel or any material. A person will simply cut or tear the cloth to a desired size and then attach the cloth to the material plate 12. In addition to a fabric cloth, other materials can also be utilized with the device 10. Due to the device's design, an abrasive cleaning pad or a sponge, can be easily attached onto the material plate 12. The device 10 can be used to on both dry and wet surfaces including floors, tabletops, windows or even boat decks, and can also be used to scrub almost any surface. As another use, the device 10 with the appropriate material attached can be used along with a chemical stripping compound to manually strip the finish off a surface. By attaching a sheet of sand paper 116 to the material plate 12, the device 10 can be used as an effective manual sanding tool.

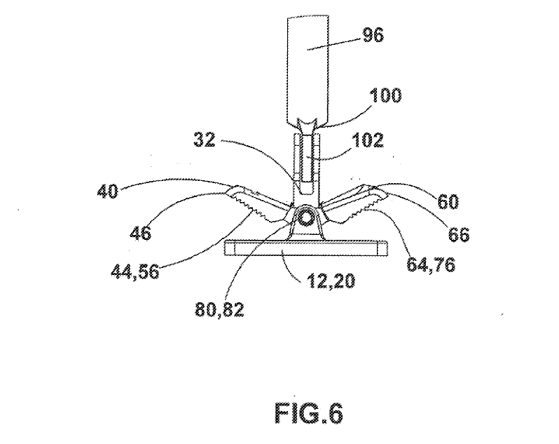

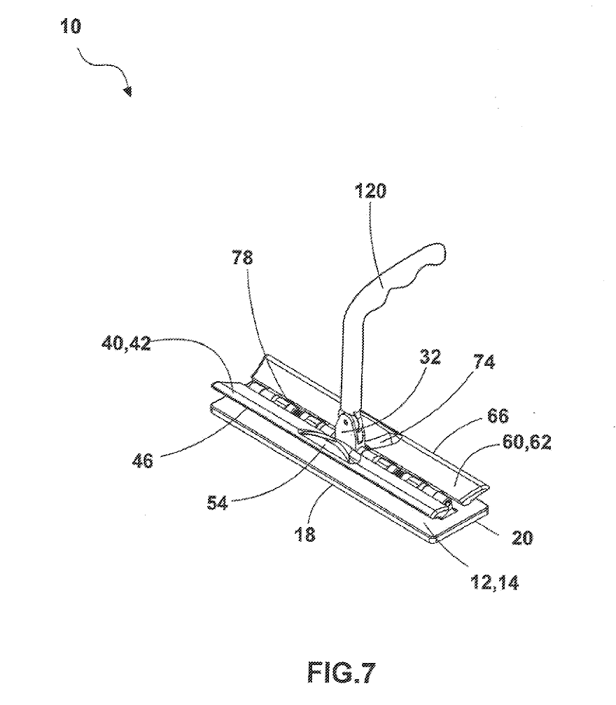

To increase the functionality of the device, other embodiments can be utilized. The elongated rod handle 96 can be replaced with an ergonomic hand grip 120, as shown in FIG. 7. The lower surfaces 44,64 of the two clips 40,60 can be serrated 56,76,as shown in FIG. 6, to provide better securement of the material 110.

The material plate 12 can be made of a malleable material that allows the shape of the material plate 12 to be formed into a desired topography. The plate 12 can include means for expanding the plate 12 to increase surface area, and/or the plate 12 can include profile attachments that allow customization of surface profiles. And, finally, the device 10 including the material plate 12, clips 40 and 60, and handle 96 or 120 can be made of plastic, metal or wood, with molded plastic preferred.

It should be noted, that the preferred embodiment as disclosed herein is only one anticipated design. Other embodiments can be realized while maintaining the inventive concept. For example, instead of two retaining clips, there can be four, six or other multiple numbers of retaining clips. And, in lieu of spring-actuated clips, the device can utilize living hinge clips, male and female detents clips, or other types.

It is also important to reiterate the importance of the drying capability. By possessing the drying capability, the true dual-use device is provided. The drying capability is not typically available on other conventional similar tools and devices.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A cleaning and drying device utilizing removably attached material comprising a material plate, a material that is removably attached to said material plate by attachment means, and a handle.

2. The cleaning and drying device as specified in claim 1 wherein said material plate is comprised of a rectangular shaped structure having an upper surface and a lower surface.

3. The cleaning and drying device as specified in claim 1 wherein said material is comprised of a fabric selected from the group consisting of cotton, wool, rayon, silk, a blended fabric and aa synthetic fabric.

4. The cleaning and drying device as specified in claim 1 wherein said attachment means for attaching said material to said material plate are comprised of a pressure assembly having a pivot rod with at least one spring that is attached to and actuates at least two material retaining clips, wherein the pivot rod and spring allow said material retaining clips to be manually extended upward under pressure, wherein when in the upward position, an edge of the material is inserted between each retaining clip and said material plate, wherein when pressure is removed, said retaining clips are forced downward, thereby trapping said material between said material retaining clips and said material plate.

5. The cleaning and drying device as specified in claim 1 wherein said handle is attached to, and extends outward from, said material plate.

6. The cleaning and drying device as specified in claim. 5 wherein said handle is comprised of an elongated rod.

7. A cleansing and drying device utilizing removably attached material comprising a material plate, a first material retaining clip, a second material retaining clip, and a handle that extends outward from, said material plate, wherein said first material retaining clip and said second material retaining clip are hingedly attached to said material plate, which by applying upward pressure causes said retaining clips to pivot upward from a center point, thereby upwardly extending a respective outer edge of each retaining clip and maintaining each edge in the upward position, wherein an edge of a material is inserted into a space between each said material plate and each said retaining clip, wherein pressure is removed, thereby causing said first material retaining clip and said second material retaining clip to be forced downward, trapping the edges of the material between the outer edge of each retaining clip and the upper surface of said material plate, wherein once in place, said material is secured at the edges and around a lower surface of said material plate and is used to clean a surface, wherein after cleaning, said material is removed and a new material is attached to said material plate.

8. The cleaning and drying device as specified in claim 7 wherein said material plate has a geometrical shape.

9. The cleaning and drying device as specified in claim 8 wherein said geometric shape is rectangular.

10. The cleaning and drying device as specified in claim 7 wherein said material plate is made of a material selected from the group consisting of plastic, metal and wood.

11. A cleaning and drying device utilizing removably attached material comprising:
a) a material plate comprising an upper surface, a lower surface, a first edge, a second edge, a third edge, a fourth edge, a plurality of upward-extending tabs each having an opening therethrough, and an upward-extending hinge with s slot having a lower opening,
b) a first material retaining clip that extends the longitudinal length of said material plate and comprises an upper surface, a lower surface, a front edge, a rear edge, at least two circular tab interfaces each having an opening, and a finger grip that extends upward from the upper surface,
c) a second material retaining clip that extends the longitudinal length of said material plate and comprises an upper surface, a lower surface, a front edge, a rear edge, at least two circular tab interfaces each having an opening, and a finger grip that extends upward from the upper surface,
d) a pressure assembly comprising a pivot rod with a first end and a second end, a first spring, and a second spring, wherein the two material retaining clips are positioned on the upper surface of said material plate with one said tab interface inserted downward between a pair of said upward-extending tabs such that the respective opening on the tab interfaces and the upward-extending tabs are aligned, with the upward-extending hinge located at the substantial center between two groups of tab interfaces and upward-extending tabs, and the lower opening on said hinge also aligned with the openings on said tab interfaces and said upward-extending tabs, wherein the first end of said rod is inserted into and sequentially passes through the openings on the two groups of tab interfaces and upward-extending tabs and said hinge, wherein as said pivot rod is inserted, said first spring is placed in alignment within the first group such that said pivot rod passes through and maintains said spring in position, and said second spring is placed in alignment within the second group such that said pivot rod passes through and maintains said spring in position, wherein once said pivot rod is completely inserted, said pressure assembly is functional, facilitating the manual upward-extending, by use of the finger grip, of said first material retaining clip under pressure, and with said front retaining clip in the upward position, an edge of a material can be inserted between the front edge of said front retaining clip and the upper surface of said material plate, wherein when pressure is removed, said clip is forced downward, trapping the material between said clip and said plate, wherein the same operation is performed with the second material retaining clip on the opposite end of the material, wherein when both ends of the material are secured, said device is utilized to clean or dry a surface, and
e) a handle comprising an upper end and a lower end, wherein located at the lower end is an attachment tab having an opening, wherein the attachment tab is inserted into the slot on said hinge, and a pin is inserted through the slot and the opening, thereby hingedly securing said handle to said material plate.

12. The cleaning and drying device as specified in claim 11 wherein said cleaning plate has a geometric shape.

13. The cleaning and drying device as specified in claim 12 wherein said geometric shape is rectangular.

14. The cleaning and drying device as specified in claim 11 wherein said cleaning plate, said retaining clips and said pressure assembly are made of a material selected from the group consisting of plastic, metal and wood.

15. The cleaning and drying device as specified in claim 11 wherein said material is made of a fabric selected from the group consisting of cotton, wool, rayon, silk, a blended fabric, and a synthetic fabric.

16. The cleaning and drying device as specified in claim 11 wherein said handle is comprised of an elongated rod.

17. The cleaning and drying device as specified in claim 11 wherein said handle is comprised of a rod with an ergonomic hand grip.

18. The cleaning and drying device as specified in claim 11 wherein said material is further comprised of an abrasive cleaning pad.

19. The cleaning and drying device as specified in claim 11 wherein said material is further comprised of sand paper.

20. The cleaning and drying device as specified in claim 11 wherein said material plate is further made of a malleable material that allows the shape of said plate to be formed into a desired topography.
